(19) United States
(12) Patent Application Publication
(10) Pub. No.: US 2013/0137077 A1
(43) Pub. Date: May 30, 2013

(54) SYSTEM AND METHOD FOR CONDUCTING HIGH STAKE EXAMINATIONS USING INTEGRATED TECHNOLOGY PLATFORM

(71) Applicant: MINDLOGICX INFRATEC LIMITED, Bangalore (IN)

(72) Inventor: SURESH ELANGOVAN, Bangalore (IN)

(73) Assignee: MINDLOGICX INFRATEC LIMITED, Bangalore (IN)

(21) Appl. No.: 13/735,140

(22) Filed: Jan. 7, 2013

(30) Foreign Application Priority Data
Jul. 7, 2010 (IN) 1930/CHE/2010
Jul. 6, 2011 (IN) PCT/IN2011/000451

(51) Int. Cl. G09B 7/00

(52) U.S. Cl. CPC G09B 7/00
USPC 434/350

(57) ABSTRACT

The present invention relates to a system and method, which enables to conduct and management of high stake examinations online in a distributed mode. More specifically, the present invention provides an integrated technology platform for conducting both online and offline examinations in a secured manner. The technology platform provides end-to-end solutions, which covers online application, online hall ticket generation, online question bank authoring, secured question paper generation and online delivery, digital evaluation of hand written answer scripts, result processing and online publishing of the result and digital generation of mark sheets and degree certificates with a unique global access code (GAC) per certificate.

### FIELD OF INVENTION

The present invention relates to a system and method, which enables to conduct and management of high stake examinations online in a distributed mode. More specifically, the present invention provides an integrated technology platform for conducting both online and offline examinations in a secured manner. The technology platform provides end-to-end solutions, which covers online application, online hall ticket generation, online question bank authoring, secured question paper generation and online delivery, digital evaluation of hand written answer scripts, and result processing and online publishing of the result etc. Further, the present invention provides for an automated examination management system, when implemented, will benefit the universities and the students to a large extent by effectively addressing issues of question paper leakage, impersonation of candidates, scams during evaluation, fake mark sheets and degree certificates etc besides bringing in complete transparency in the system which has become essential in the wake of the process being brought under response to intervention (RtI) framework.

### DESCRIPTION OF PRIOR ART

The traditional system for managing examination by universities experiences numerous inconveniences and irregularities. Starting from the issuance of applications for examination till the issuance of marks sheets and degree certificates, traditional examination systems undergoes various kinds of abnormalities and complexities. Most of the universities undergo serious problems to ensure the conduct of foolproof examinations and provide tamper proof certificates.

The traditional systems have paper-based applications for examination, valuation and issuance of certificate. Some of the major problems are explained below:

The traditional system is not capable of managing huge data related to the students like their academic and performance record, marks sheets etc. Since the exams are conducted at hundreds of different examinations centers distributed over different locations in various affiliated colleges and distance education centers and since the number of candidates appearing for the exams are also large, the transportation of question papers to these examination centers one or two days before the date of examination would pose a threat of question paper leakage. When such a mishap occurs in any of the examination centers which demands for rescheduling or cancellation of the exams at selected centers, creates nuisance, may lead to break down of the entire system, and throws a blow on the credibility of the university. In addition, conducting examination at distantly located study centers is almost impossible in the existing system.

The manual evaluation and re-evaluating procedures are highly complicated and cannot guarantee accurate valuation. There are high incidence of evaluation malpractice and inaccuracies. Moreover, in the traditional system the evaluators have to travel to distant locations for evaluation and stay outstation for long periods. Issuance of fake certificates and tampering with the original certificate by anti social elements are increasing in the traditional examination systems. Besides all these, the cost of conducting such high stake exam in a distributed mode is very high which also affects the quality of the examination.

Some attempts have been made in the past to overcome the limitations of prior arts such as those disclosed in the following:

U.S. Pat. No. 7,099,620 is an invention titled “METHOD AND APPARATUS FOR ADMINISTERING AN INTERNET BASED EXAMINATION TO REMOTE SITES”, which deals with a method and system for administering a secure, Internet based examination at remote sites.
U.S. Pat. No. 6,112,049 is an invention titled “COMPUTER NETWORK BASED TESTING SYSTEM”, which relates to a method and system for designing, administering and taking tests through a computer network or other information distribution media.
U.S. Pat. No. 6,684,053 is a prior art titled “ON-LINE EDUCATIONAL SYSTEM FOR PROCESSING EXAM QUESTIONS AND ANSWERS”, which discloses a method and an apparatus for providing exam questions for use with an online educational system provides for online testing of users.
US 2003207242 is a prior art titled “METHOD FOR GENERATING CUSTOMIZABLE COMPARATIVE ONLINE TESTING REPORTS AND FOR MONITORING THE COMPARATIVE PERFORMANCE OF TEST TAKERS” which deals with a method for generating comparative online testing reports for a variety of competitive examinations is implemented.

KR 20100006799 is an invention titled “ONLINE ASSESSMENT ITEM MANAGEMENT AND METHOD THEREOF” which relates to an online evaluation questions management system and a method thereof for managing items through intrinsic codes of the item are provided to efficiently evaluate the learning level of a learner by recording reaction time which learner inputs to items.

WO 2008030993 is an invention titled “SECURITY AND TAMPER RESISTANCE FOR HIGH STAKES ONLINE TESTING” which relates to methods and systems for distributing educational content and more particularly to systems and methods for distributing and administering high-stakes exams.
KR 20040021170 is a prior art titled “EVALUATION SYSTEM USING ONLINE NETWORK AND METHOD THEREOF”, which discloses an evaluation system using an online network and a method thereof to undergo a qualifying examination on a desired place and time by evaluating various examinations through the network.
CN 101499054 is a prior art titled “ON-LINE NETWORK LEARNING AND EXAMINATION SYSTEM BASED ON INTERNET”, which teaches about on-line network exam system based on internet and mobile communication network, consisting of an examination question database, a teacher operation terminal, a data exchanging system and an EEB student operator.

Whereby, it is desirable to provide cost effective, reliable and trouble-free system addressing the above problems for conducting such high stake examinations by universities. The solution is to take care of complete life cycle of examination ranging from online filing of application, online generation and issuance of hall tickets with the candidates' photograph embedded, question bank authoring, secured question paper generation and delivery, automated evaluation process, publishing the results and issuance of tamper proof certificates etc.

The present invention avoids the problems/disadvantages noted above and overcome other problems encountered in conventional methods. The objects, advantages and novel features of the invention may be realized and obtained by means of the instrumentalities and combinations particularly pointed out in the detailed description.

### OBJECTS OF INVENTION

One or more of the problems of the conventional prior art may be overcome by various embodiments of the present invention.

Accordingly, it is the basic object of the present invention to provide a computer implemented system and method for conducting and managing examinations.

It is another object of the present invention to provide a computer implemented system and method for conducting and managing examinations virtually, i.e., through online vide the internet.

It is another object of the present invention, which helps to save time and cost by automating the examination processes.

It is another object of the present invention to provide a computer implemented system and method for conducting and managing examinations, wherein the question papers are delivered just before the examination with secret codes for authorized access. The period of early delivery is predefined or user configurable.

It is another object of the present invention, wherein the question papers are delivered only to specific pre-registered computer systems.

It is yet another object of the present invention to provide a computer implemented system and method for conducting and managing examination, wherein the system facilitates easy scheduling and rescheduling of examination.

It is another object of the present invention to provide a computer implemented system and method for conducting and managing examination, which enables quick generation and issuance of hall tickets.

It is another object of the present invention to provide a computer implemented system and method for conducting and managing examination, wherein the evaluation of answer scripts is done through a secured technology platform, which will be accessed only by authorized evaluators of the university (online evaluation).

It is another object of the present invention to provide computer-implemented system, wherein an intelligent dashboard is provided to the evaluator for the purpose of moderation.

It is yet another object of the present invention to provide a computer implemented system and method for conducting and managing examination, wherein an enhanced facility for online result announcement with the grade obtained and an analysis of the candidates' performance is provided.

It is another object of the present invention to provide a computer implemented system and method for conducting and managing examination with multiple levels of security checks such as user level and system level security.

It is another object of the present invention to provide maintenance free computer implemented system and method for conducting and managing examination, wherein the technical support issues can be handled in modular manner thereby not affecting the individual nodes during the running of the entire project.

It is another object of the present invention to provide a browser-based application for the whole examination management offering both online and offline exam solutions.

It is another object of the present invention, wherein a Managed Application Service (MAS) takes care of all the up gradation, maintenance and support.

It is another object of the present invention, wherein the system can handle large volume of data at a time.

It is yet another object of the present invention to provide a scalable solution for conducting and managing examination, wherein the system can be implemented in any environment at any time using internet and intranet.

It is another object of the present invention wherein the computer implemented system comprises:
1. Distributed authoring of question papers;
2. Secured question paper delivery;
3. Digital valuation system;
4. Result process and publication; and
5. Digital generation of degree certificates

It is another object of the present invention, wherein the system eliminates the question paper leakage ensures smooth conduct of the exam.

It is another object of the present invention, wherein the hardware-based authentications are used to ensure the process is highly secure and foolproof.

It is another object of the present invention, wherein the examinations are conducted in all the centers irrespective of their geographical distance.

It is another object of the present invention, wherein a web based authoring tool is used for setting the question papers by subject experts from different parts of the world in the shortest time.

It is another object of the present invention, wherein the digital evaluation of answer scripts includes mobile evaluation, whereby the evaluation is done in mobile mode using secured technology platform, which allows evaluators to take the answer script to be evaluated with them in a mobile device in a secure manner to be evaluated on their own schedule and location of choice.

It is another object of the present invention, wherein the examination results are directly made available to the candidates' email address or to their mobile through SMS.

It is another object of the present invention to provide a system, wherein authority can generate college wise, subject wise and branch wise result reports.

It is yet another object of the present invention to support digital generation of mark sheets and degree certificate with a unique global access code (GAC), thereby eliminating the problems related to fake mark sheets and certificates.

It is yet another object of the present invention, wherein the prospective employer can check the credentials of the certificates from any part of the world.

It is another object of the present invention to provide a centralized profile management facility to students for easy verification of their attendance, fee and internal marks.

It is another object of the present invention to facilitate online collaboration among students using closed user groups and message boards.

It is another object of the present invention to provide a business intelligence enabled system for real time performance analysis and tracking using tools such as dashboards.

It is another object of the present invention to provide a cost effective computer implemented method for conducting and managing examinations by offering a packaged solution under the managed application service.

It is another object of the present invention, wherein the question papers are delivered via an intelligent integrated system in an encrypted format.

It is another object of the present invention, wherein the 128 (Plus) Bit encryption ensures secured and faster delivery of the question papers to the remote locations.

It is another object of the present invention, wherein the question papers are decrypted and printed at the examination centers by the authorized persons.

It is yet another object of the present invention, wherein the question papers are uploaded and are made available to the Head of the Faculty and the Controller of Examination for validation.

It is yet another object of the present invention, wherein the validated questions are updated into the question bank and are made available for use in future examinations.

A still further object of the present invention relates to a computer implemented method for conducting and managing examinations wherein the students identity is kept as secret by allocating dummy number.

### SUMMARY OF INVENTION

Thus, according to the basic aspect of the present invention, there is provided a secure system for conducting and managing examinations comprising:

One or more memories for storing instructions and data;
A server with one or more processing units that execute instructions and process the data;
A central repository (database for storing all data);
A means for generating and issuing hall tickets;
A platform for evaluation in centralized, distributed and mobile mode;
A means for authorizing evaluators;
A means for broadcasting the results;
A means for candidate performance analysis;
A means for providing unique global access code for each digitally generated mark sheets and certificates;
A means for encryption and decryption of data; and
Integrated dashboards,
wherein the system is implemented without being hardware dependent and accessible through standard web browsers,
wherein question papers can be authored and remotely uploaded to the database,
wherein the server provides for secure access codes for delivery of question papers,
wherein the broadcasting can be both online and offline mode,
wherein security checks are conducted at both user and system level, and
wherein all data transfer using the system is in an encrypted format.

According to another aspect of the present invention, the period of delivery of question paper is predefined or user configurable.

According to yet another aspect of the present invention, the examinations can be scheduled and/or rescheduled.

According to yet another aspect of the present invention, the broadcasting of results is via SMS to a mobile phone.

According to further aspect of the present invention, the data stored in the database includes question papers, answer scripts, results, attendance and fees.

According to a still further aspect of the present invention, the data, which is stored in the database can be extrapolated to create customized reports.

According to a still further aspect of the present invention, using the unique global access code credentials and certificates of mark sheets can be verified.

In accordance with another aspect of the present invention, the integrated dashboards provide decision support system for evaluators.

In the above invention, the system can be managed in a modular manner without affecting individual nodes.

In the above invention, the management includes up gradation, maintenance and support.

In the above invention, the system is accessible only through computers where media access control (MAC) ID have been pre-registered or authenticated.

In accordance with another aspect of the present invention, there is provided a method for conducting and managing examinations comprising:

Distributed authoring of question papers;
Secured delivering of question paper;
Digital evaluating of answer sheets;
Result processing and publication; and
Digital generating of certificates,
wherein a web based authoring tool is used for setting the question papers,
wherein the uploaded questions are validated and updated in question banks,
wherein the question papers are encrypted and decrypted before delivery,
wherein hardware based authentications ensures the whole process is highly secure and fool-proof, and
wherein the digital evaluation of answer scripts is in centralized, distributed and mobile mode.

### BRIEF DESCRIPTION OF THE DRAWINGS

FIG. 1 illustrates the e-Governance system according to the present invention.

FIG. 2 illustrates the question paper delivery system according to the present invention.

FIG. 3 is a flow chart that illustrates the question paper delivery process according to the present invention.

FIG. 4 illustrates the digital valuation system according to the present invention.

FIG. 5 is a flow chart that illustrates the digital valuation process flow according to the present invention.

FIG. 6 illustrates the result processing system according to the present invention

FIG. 7 is a flow chart that illustrates the result processing flow according to the present invention.

FIG. 8 illustrates the certificate generating system according to the present invention.

FIG. 9 is a flow chart that illustrates the certificate generating process according to the present invention.

### DETAIL DESCRIPTION OF THE INVENTION WITH REFERENCE TO THE ACCOMPANYING DRAWINGS

Thus, as discussed above, the present invention provides for a method and system for conducting examinations, which addresses the major issues such as question paper leakage, delays in result announcements, fake mark sheets/certificates and other malpractices in examination processes. The system and method according to the present invention provides for online and offline examination, scanning of answer scripts to digital a format, digital valuation of answer scripts in a connected (centralized and distributed) or disconnected (mobile) mode, processing of results followed by publishing and certificate generation at any time. An all-encompassing e-Governance infrastructure facilitates the complete examination cycle. The system handles the complete life cycle of examination management ranging from online application, hall ticket generation, question bank authoring, secured question paper generation, automated evaluation process and publishing of the result. The system is robust enough to handle large volume of data and helps universities save time and costs by automating the examination processes.

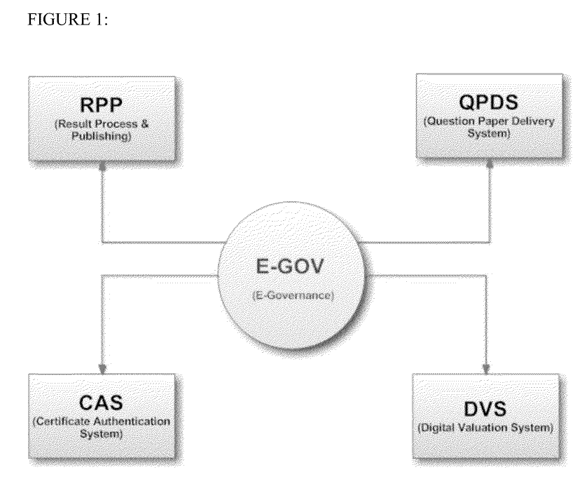

Reference is now invited to accompanying to FIG. 1 that illustrates the e-Governance system which drives the overall data for managing the QPDS/DVS/Result Processing and Certificate authentication systems.

The system comprising:
1. Question paper delivery system;
2. Digital valuation system;
3. Result processing and publication system; and
4. Certificate authentication system

The secured system for conducting and managing examination using integrated technology platform according to the present invention, comprises one or more memories for storing instructions and data; a server with one or more processing units that execute instructions and process the data; a central repository (database for storing all data); a means for generating and issuing hall tickets; a platform for evaluation; a means for authorizing evaluators; a means for broadcasting the results; a means for candidate performance analysis; a means for providing unique global access code for each digitally generated mark sheets and certificates; a means for encryption and decryption of data; and integrated dashboards. The system is implemented without being hardware dependent and accessible through standard web browsers. The data stored in the database includes question papers, answer scripts, results, attendance and fees. The data, which is stored in the database can be extrapolated to create customized reports.

In another aspect of the present invention, the method comprises:

### 1. Question Paper Delivery System

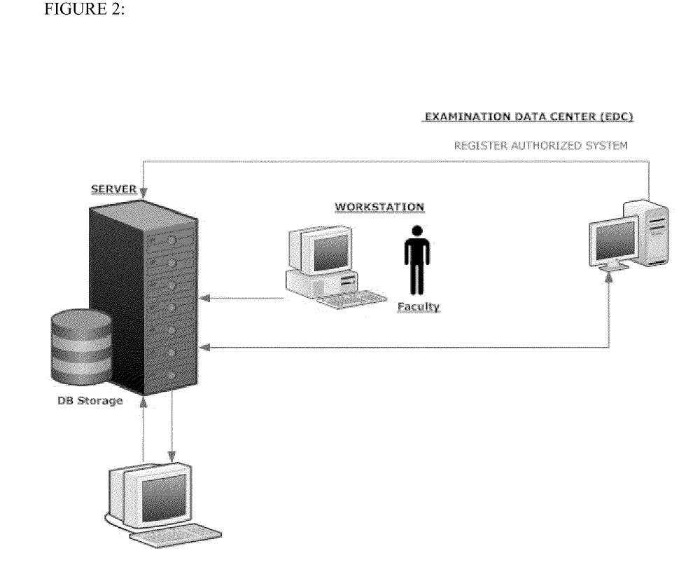

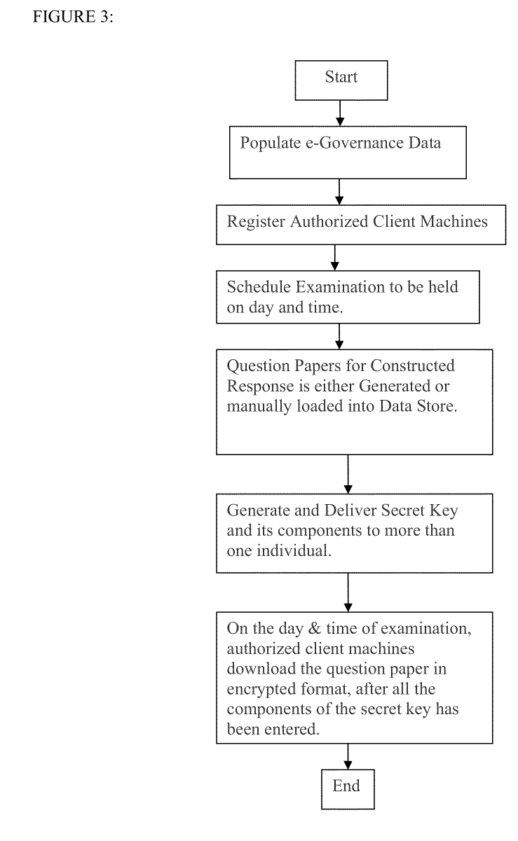

Reference is now invited to the accompanying FIGS. 2 and 3, which illustrates the question paper delivery system and a flow chart illustrating the question paper delivery respectively.

The system has a web based authoring tool, which enables question papers to be set by subject experts from different parts of the world—thus giving the convenience of having the best set of question papers in the shortest time possible. Question papers for constructed response is either generated or manually loaded into data store. The uploaded questions are available for the Head of the faculty cell and the Controller of Examination for validation. Only validated and approved questions are updated into question bank and the same are made available for use in examinations.

The system helps to remove the menace of question paper leakage for examinations conducted by universities, premier institutes of India. This can be achieved by transferring the question papers online to all examination centers in an encrypted format. Hence, the question papers can be seen only 30 minutes before examination. Question papers are delivered in a highly secured manner using secure access codes to the examination centers. At the examination center also, only authorized person/s will use their security to decrypt and then print using high speed printers. Hardware based authentications further ensure the whole process is highly secure and fool-proof.

Question Paper Delivery System (QPDS) is a unique four-check system for secure delivery of question paper from source/transmitting computer to destination/receiving computer. It works by employing time, Media Access Control (MAC) ID and a multipart secret key, which is delivered to multiple individual verification mechanism to ensure that there is no leakage of question paper. On the day and time of examination, authorized client machines download the question paper in encrypted format, after all the components of the secret key has been entered. Question paper cannot be delivered before or after predefined time duration or user configurable. Question paper can only be delivered to computers having MAC ID, which have been pre-registered and or acknowledge before hand. Question paper can only be delivered when a valid multi part secret key is provided to the system. The fourth check of the system is to transmit an encrypted question paper from the source to destination computer.

### 2. Digital Valuation System

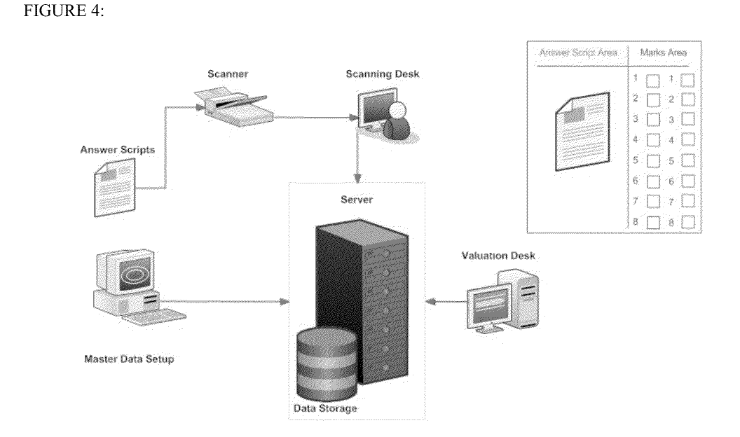

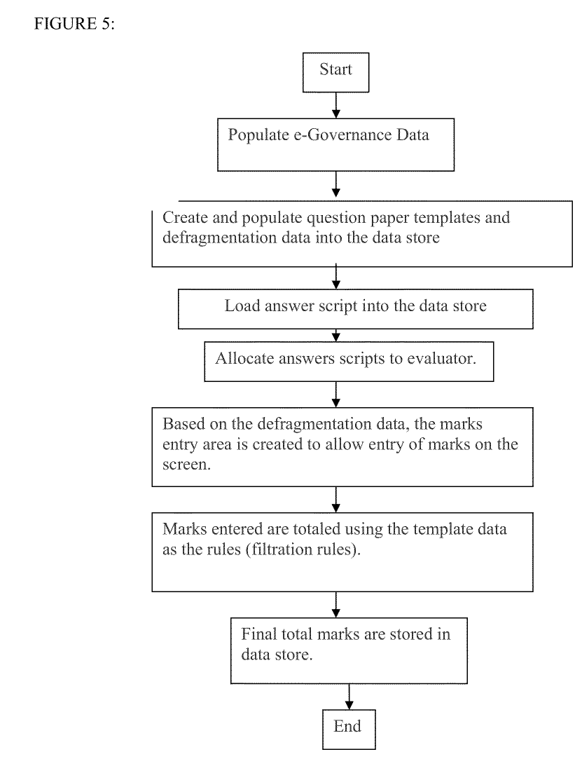

Reference is now invited to the accompanying FIGS. 4 and 5, which illustrates the digital valuation system and a flow chart describing the process of digital valuation system respectively.

Digital valuation system (DVS) is a unique system that allows evaluators of constructed response or subjective answers, to view digital format copies of the answer scripts and allocate marks against each answered question. Question papers having different formats and structures are mapped into the system by a two-step process, generic template and defragmentation of individual questions. Templates are used for final marks calculation. Defragmentation data is used to dynamically create a marks entry area on the screen, validate the marks allocation per question and to display the question statement.

The answer scripts are scanned by the scanner, are loaded into the data store, and are allocated to the evaluator. The evaluation of answer scripts is done totally through electronic media. The process includes dummy number allocation, digitizing the answer scripts, evaluation and mark entry. Only authorized evaluators can evaluate the answer scripts. During the evaluation process, evaluators get reference answer sheets for questions and student answer scripts. Based on the defragmentation data, the marks entry area is created to allow entry of marks on the screen. Marks entered are added using the template data as the rules (filtration rules) and the final total marks are stored in data store. In the entire evaluation process, student identity is totally masked to avoid any kind of malpractices. The intelligent dashboard provided as a part of the examination management system can be used by the evaluator for the purpose of moderation. Re-evaluation process is also made easy by digitizing the answer scripts. There is also an option for payment management for the evaluators.

### 3. Result Processing and Publication System

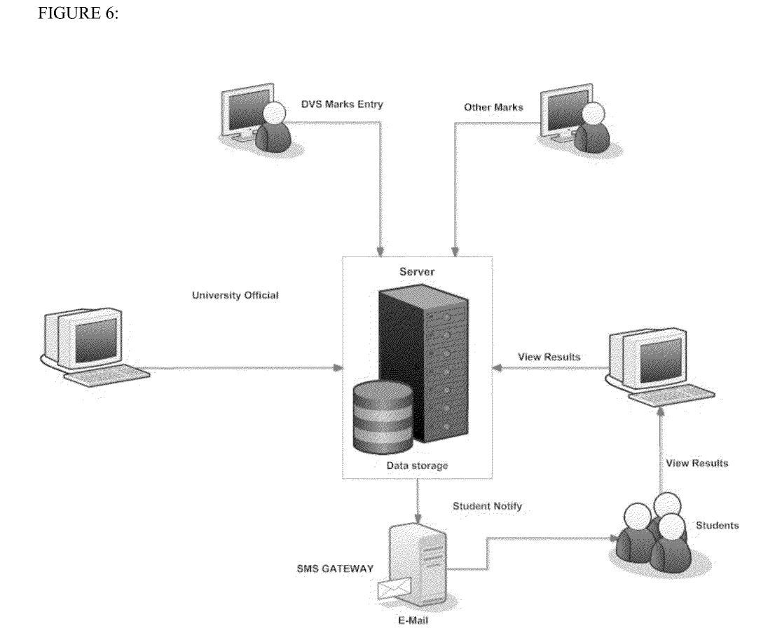

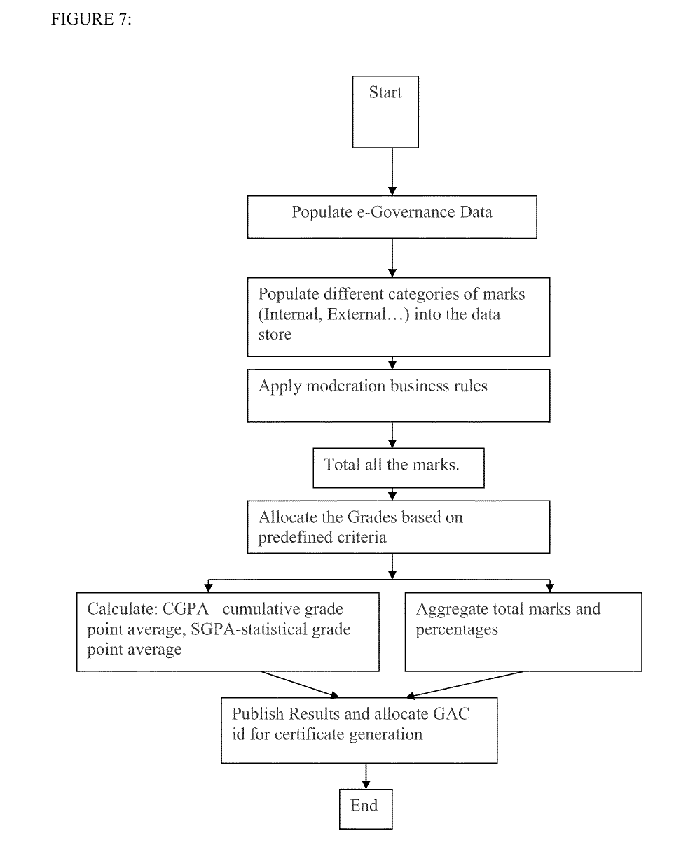

Reference is now invited to the accompanying FIGS. 6 and 7, which illustrates the result processing and publication system and method involved in result processing and publication respectively.

Result processing and publication system is one of the most important systems of the present invention. Result processing system allows processing of results by applying various moderation parameters. The solution has integrated dashboards that act as decision support system. Different categories of marks, such as internal, external, practical etc. are populated into the data store. The moderation business rule is applied to this and total marks are calculated. Grades are allocated according to the predefined criteria. There can be two different criteria for grade calculation. 1. Cumulative grade point average (CGPA) or statistical grade point average (SGPA) and 2. Aggregate total marks and percentages. The result of the examination conducted is available online with an analysis of the candidates' performance and grade obtained. Result processing system is well defined to such an extent that it is easy to define the grading system, managing internal and external marks etc. The candidates would also get their results published/broadcasted directly to their respective email IDs or SMS. This feature of the system provides an enhanced facility for online result announcements, short-listing of students for the next semester, statistics generations, comparison of results and many such sophisticated features. Further the university authorities can also generate college wise, subject wise and branch wise result reports.

### 4. Certificate Authentication System

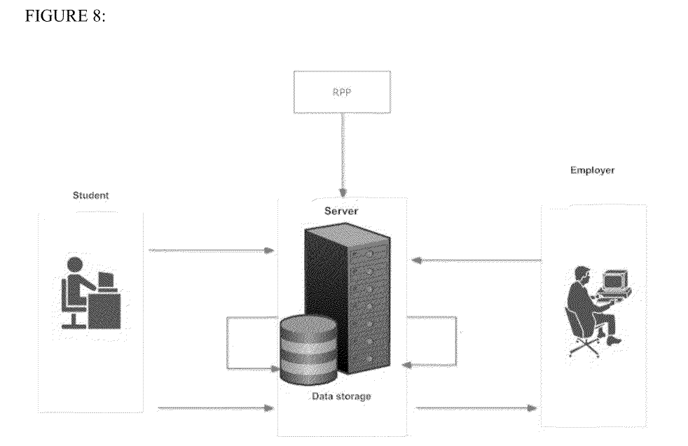

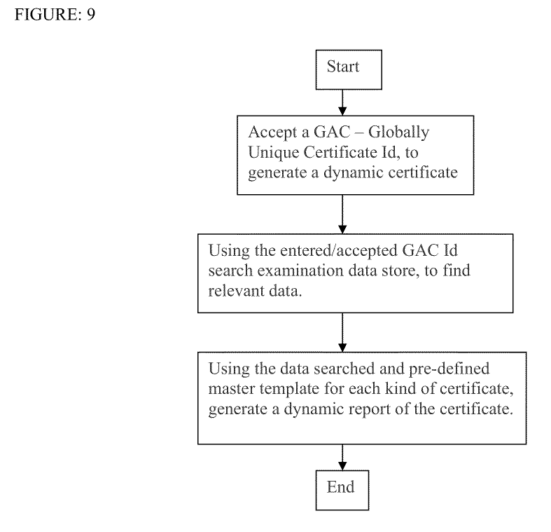

Reference is now invited to the accompanying FIGS. 8 and 9, which illustrates the certificate authentication system and method involved in the certificate authentication respectively.

The system supports the digital generation of mark sheets and degree certificates with a unique global access code (GAC) per certificate. Each certificate is generated dynamically every time a request is made against a GAC. This eliminates the problems related to fake mark sheets and certificates. Using GAC, the credentials of the certificates may be checked from any part of the world by the prospective employer. The underlying code generation engine is based on the same components that comprise on-line banking and commerce. The certificate generation involves the following steps:

Accept a GAC Id, to generate a dynamic certificate. Using the entered/accepted GAC Id, search examination data store, to find relevant data. Using the data searched and pre-defined master template for each kind of certificate dynamic report of the certificate is generated.

The following are some of the advantages of the present invention:

Reducing manual/paper work;
Getting out the results/analysis quickly;
Getting out the results/analysis quickly;
Acquiring the ability to conduct examinations at multi-sites simultaneously;
Produce necessary reports from the exam process; and
Ability to incorporate webcam surveillance, on-line registration and adding intelligence in the whole examination process.

Moreover, the present invention can be used as any time, anywhere assessment model both in intranet and internet.

We claim:

1. A secure system for conducting and managing examinations comprising:
One or more memories for storing instructions and data;
A server with one or more processing units that execute instructions and process the data;
A central repository (database for storing all data);
A means for generating and issuing hall tickets;
A means for secure delivery of question paper;
A platform for evaluation in centralized, distributed and mobile mode;
A means for authorizing evaluators;
A means for broadcasting the results;
A means for candidate performance analysis;
A means for providing unique global access code for each digitally generated mark sheets and certificates from stored data on request;
A means for encryption and decryption of data; and
Integrated dashboards,
wherein the system is implemented without being hardware dependent and accessible through standard web browsers,
wherein the question papers can be authored and remotely uploaded to the database,
wherein the server provides for secure access codes for delivery and printing of question papers,
wherein the broadcasting can be both online and offline mode,
wherein security checks are conducted at both user and system level,
wherein all data transfer using the system is in an encrypted format,
wherein the question papers are securely delivered by employing time, Media Access Control (MAC) ID, a multipart secret key and hardware based authentications,
wherein the question papers are decrypted and printed only at the examination centers by the authorized persons, and
wherein during digital evaluation of scanned answer scripts the marking area is generated onscreen from defragmented data.

2. The system as claimed in claim 1, wherein the period of delivery and printing of question paper is predefined or user configurable.

3. The system as claimed in claim 1, wherein the examinations can be scheduled and/or rescheduled.

4. The system as claimed in claim 1, wherein the broadcasting of results is via SMS to a mobile phone.

5. The system as claimed in claim 1, wherein the data stored in the database includes question papers, answer scripts, results, attendance and fees.

6. The system as claimed in claim 5, wherein the data, which is stored in the database, can be extrapolated to create customized reports.

7. The system as claimed in claim 1, wherein using the unique global access code credentials and certificates of mark sheets can be verified.

8. The system as claimed in claim 1, wherein the integrated dashboards provide decision support system for evaluating and processing of results using moderation parameters.

9. The system as claimed in claim 1, wherein the system can be managed in a modular manner without affecting individual nodes.

10. The system as claimed in claim 9, wherein the management includes up gradation, maintenance and support.

11. The system as claimed in claim 1, wherein the system is accessible only through computers where media access control (MAC) ID have been pre-registered or authenticated.

12. A method for conducting and managing examinations using the system as claimed in claim 1, the method comprising:
Distributed authoring of question papers;
Secured delivering and printing of question papers;
Digital evaluating of answer scripts;
Result processing and publication; and
Digital generating of certificates,
wherein a web based authoring tool is used for setting the question papers,
wherein the uploaded questions are validated and updated in question banks,
wherein the question papers are encrypted and decrypted before printing,
wherein hardware based authentications ensures the whole process is highly secure and fool-proof,
wherein the digital evaluation of answer scripts is in centralized, distributed and mobile mode,
wherein the question papers are delivered by employing time, Media Access Control (MAC) ID,
a multipart secret key and hardware based authentications,
wherein the question papers are decrypted and printed at the examination centers by the authorized persons, and
wherein during digital evaluation of scanned answer scripts the marking area is generated onscreen from defragmented data.
